(19) United States
(12) Patent Application Publication
(10) Pub. No.: US 2016/0355119 A1
(43) Pub. Date: Dec. 8, 2016

(54) DEVICE FOR SECURING OF LOAD

(71) Applicant: Rainer Karl SCHUH, Wiener Neustadt (AT)

(72) Inventor: Rainer SCHUH, Wiener Neustadt (AT)

(21) Appl. No.: 15/117,835

(22) PCT Filed: Jan. 27, 2015
(86) PCT No.: PCT/AT2015/050023

§ 371 Date: Aug. 10, 2016

(30) Foreign Application Priority Data
Feb. 10, 2014 (AT) A 50096/2014

(51) Int. Cl. B60P 7/08

(52) U.S. Cl. CPC B60P 7/0815

(57) ABSTRACT

A device for securing of load in the interior of a lorry body, with a rail which has a pitch and on which a strap can be placed by a strap holder and can be secured by a lock. In order to be able easily to secure the strap holder at the appropriate location, a spacing is provided between lock and strap holder. The spacing is at least triple the length of a pitch of the rail. The strap holder and the lock can be connected by a rod which is insertable into the rail.

The invention concerns a load securing device in the interior of a truck body according to the preamble of claim 1 and U.S. Pat. No. 3,344,749. DE 299 01 216, US 2009/0243331, U.S. Pat. No. 3,605,637 and DE 199 62 810 also show such devices. The content of these documents is made the content of the present description by reference for jurisdictions in which this is possible.

The first named document deals with securing a load, for example, in the interior of a truck body. It is then proposed to insert a type of lock movably into a rail having an undercut groove and a groove edge, which has arc-like, especially circular arc-like widenings so that a pitch of constant length is defined in the longitudinal direction of the rail, by means of at least two feet with widened ends and to secure or release it with a rotatable, spring-loaded blocking pin, depending on its position. A mounting ring for a strap is provided in the area between the two feet. Such rails are colloquially called “airline rails” because of their original area of application in the transport field.

DE 199 62 810 shows a similar fastening device especially conceived for fastening of roll containers but significantly simplified in comparison with the prior art at that time, in which the strap engages on a lock in the center, just as in DE 299 01 216.

The straps in US 2009/0243331 and U.S. Pat. No. 3,605,637, which show similar devices, are arranged directly next to the handles for releasing or fastening of the locks.

It can be prescribed in these and similar devices that the lock can be raised from the rail in a certain position relative to the pitch, in which case the widening of the feet is no greater than the recesses of the groove edge. Fastening of the lock must then occur in its position in the rail so that the feet are not flush with the recesses.

A deficiency also not eliminated by the cited DE 199 62 810 lies in the time constraint, which generally occurs in shipping, and results in a situation in which the responsible employees position the fasteners for the straps in the horizontal rails, if possible, at locations that are readily and quickly accessible to them, even if the fastening devices in the rails, which have a corresponding pitch, can be displaced by one or more such pitches. This means that, even when the strap is relatively well-tightened, and this unfortunately does not always occur, actual securing of the load or rolling cart does not occur because of the flexibility of the strap and the unfavorable position of the strap running only across the longitudinal axis of the truck. It would be necessary to move the fastenings for the strap into the gaps remaining laterally between the side board and rail, on the one hand, and the next load or rolling cart, on the other, so that reliable tensile forces occur with a component in the direction toward the front wall, against which the rolling carts lie.

The objective of the invention is to avoid this drawback of all previously known devices and provide fastening in such a rail, especially a so-called airline rail, which makes it possible without time or logistic constraints to achieve a favorable trend of the lashing strap, which is U-shaped or V-shaped in top view.

These objectives are achieved according to the invention by the features mentioned in the characterizing part of claim 1; in other words, the fastening part with the handle for loosening and fastening on the rail, and the lock, which is provided at a distance from the mount for the strap, in which case this distance is at least three times, preferably at least five times and more preferably at least seven times the length of the pitch of the rail and in which the distance is preferably spanned by a rod which runs in the rail in the mounted state and therefore does not protrude above it.

In this way, the fastening device can be freely accessible and the mount for the strap is already situated deep in the gap between the side board and load. The strap therefore always emerges from this gap at least roughly parallel to or not at an angle of more than 45° relative to the travel direction or longitudinal center direction of the vehicle, and any stress in this direction leads to useful and reliable securing of the load or roll containers, which are no longer mentioned subsequently as an alternative.

At least one holding foot, which cooperates with recesses of the rails, is recommended for anchoring the strap holder in the rail.

If at least one lock foot is provided similarly for the lock, then it is advantageous with respect to insertion of the device if an offset exists in the longitudinal direction between the holding foot and the lock foot relative to the pitch of the recesses. A positive offset is then preferred.

Fastening of the strap on the strap holder has thus far occurred by means of a ring protruding roughly in the longitudinal direction of the rail, through which the strap is looped. This is a drawback because of crumpling of the strap. Consistent with the invention, the strap holder therefore has a pin running across the longitudinal direction of the rail, around which the strap is looped. As an alternative, the strap holder can also have a pin positioned substantially perpendicular to the rail, against which the strap is fastened so as to pivot laterally.

The invention is further explained below with reference to the drawing. In the drawing:

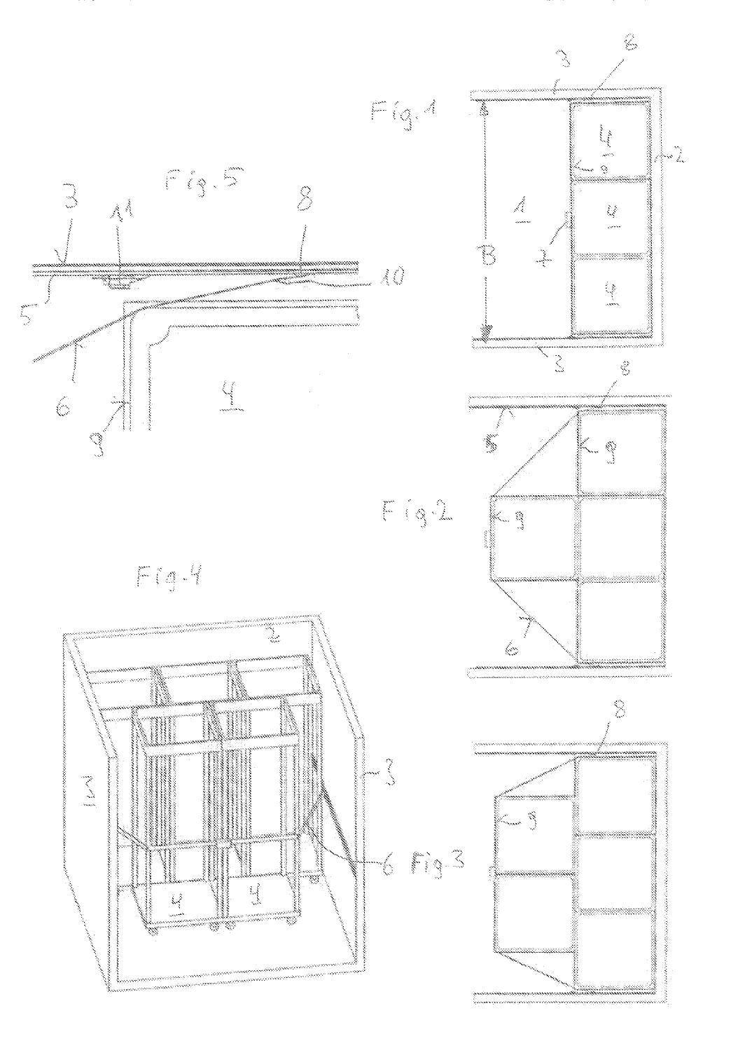

FIGS. 1 to 3 show schematic horizontal sections in the area of the front wall of a partially loaded truck,

FIG. 4 shows the situation of FIG. 3 in a schematic perspective view,

FIG. 5 shows a detail of FIGS. 2 and 3,

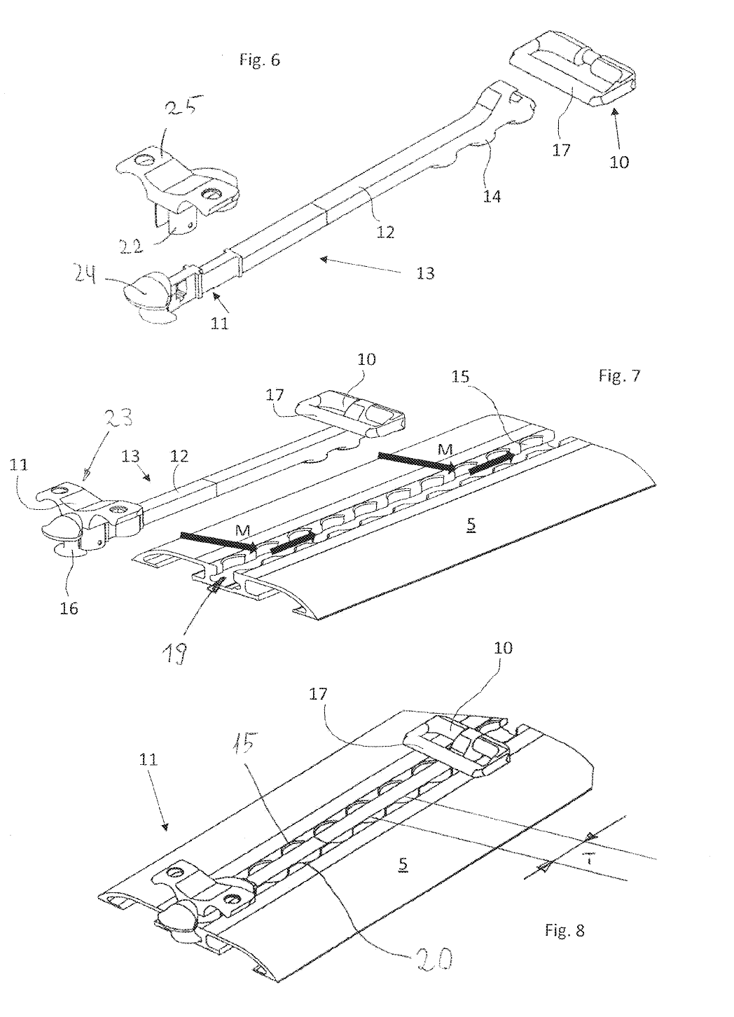

FIGS. 6 to 8 show an embodiment of the device according to the invention, broken down in the first case (FIG. 6), assembled for insertion into a rail in the second case (FIG. 7) and finally in the inserted state (FIG. 8),

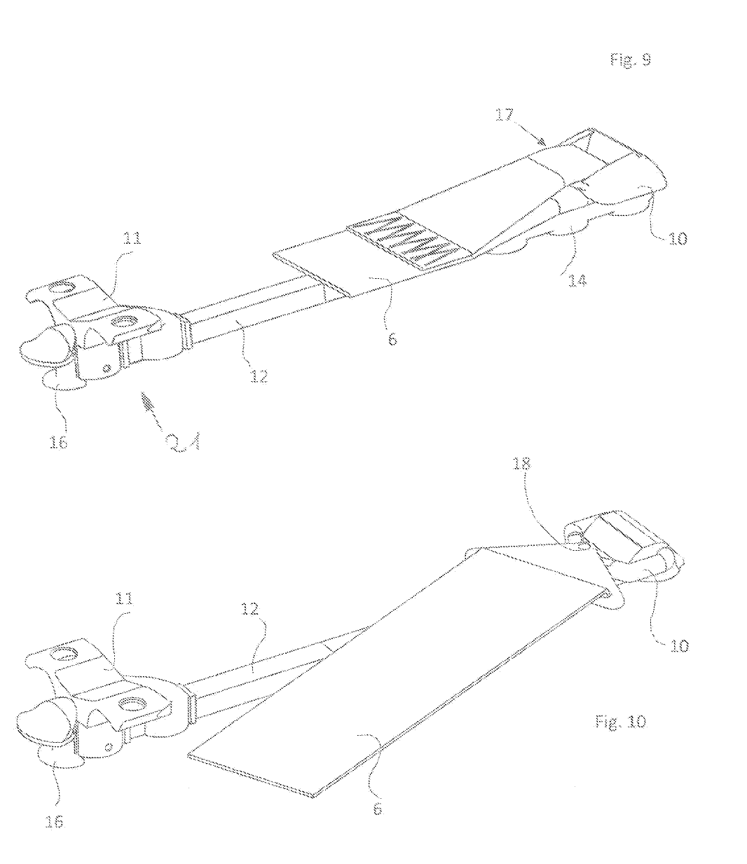

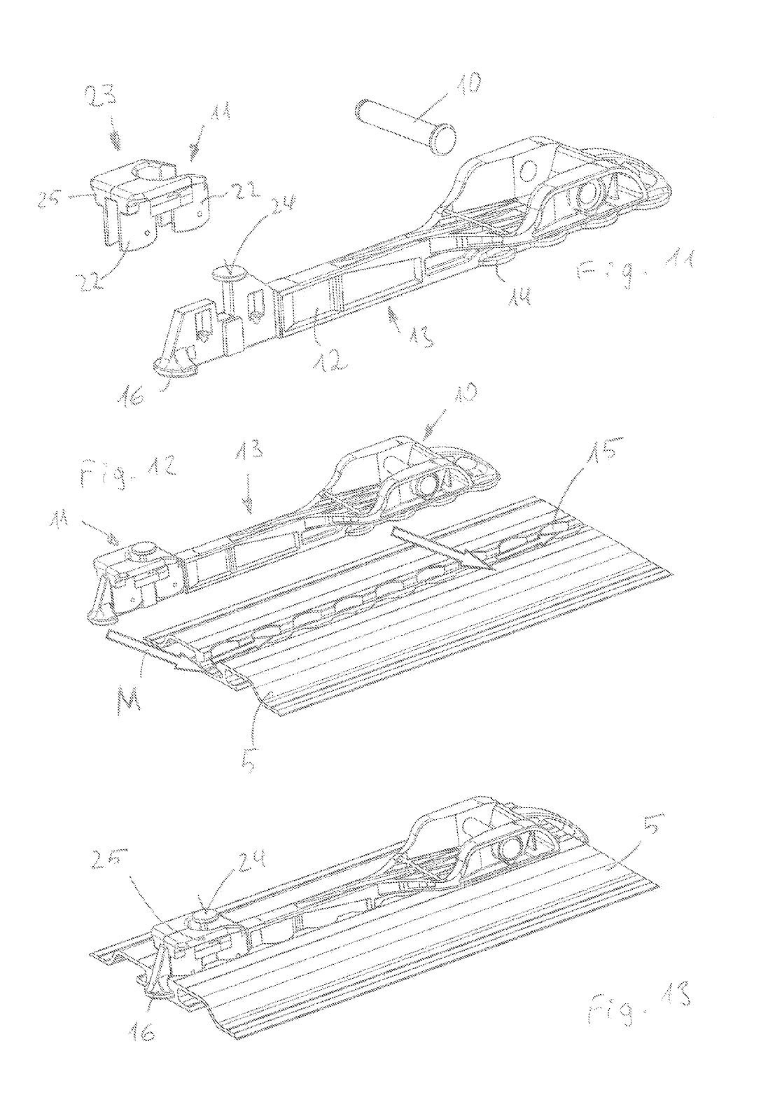

FIGS. 9 and 10 show two alternative fastenings of the strap on the strap holder and

FIGS. 11 to 13 show an alternative embodiment in views similar to FIGS. 6 to 8.

FIG. 1 shows in a purely schematic horizontal section the area of the front wall 2 of the truck body 1 together with the connected side boards 3. In the interior of structure 1, three roll containers 4 are situated, which, in order to utilize the loading capacity as best as possible, substantially fill up the entire free width B of the interior of the truck body. A horizontal rail 5 is provided firmly mounted on the inside of side boards 3 (this is indicated in FIGS. 1-5 by the thicker structure of the corresponding line). The roll containers 4 are secured by means of a strap 6, which is tightened by a tightener 7. FIGS. 1 to 3 show the desired situation: the strap 6 is suspended on rails 5 at a connection site 8, which lies closer to the front wall 2 than the free surfaces 9 of the roll container 4. This is particularly apparent in FIG. 5.

As can be deduced from FIGS. 2 and 3, the correctly positioned strap 6 in the operating state assumes a roughly U-shaped or V-shaped trend, depending on the number and arrangement of the load or roll containers to be secured. For improved clarity, FIG. 4 shows the situation of FIG. 3 in a perspective view.

As is readily apparent from FIGS. 1 to 5, there are extreme space constraints precisely in the area in which the securing device 13 (FIGS. 6, 7) is to be mounted in or on rail 5, which prevent or hamper fastening at the correct connection site 8. Even if certain accessibility exists, shippers operating under time constraints generally have a strong aversion to advancing the strap locks to the corresponding connection sites 8 and fastening them thereto. Instead, they are generally content to fasten them directly in the area of the front free surfaces 9 of the roll container 4 or strapped load.

This problem is solved according to the invention (see FIGS. 5 to 8 and 11 to 13) in that a spacing is provided in the fastening device 13 according to the invention between a strap holder 10 and a lock 11 for fastening in the rail 5, preferably produced by a rod 12 whose cross section is designed so that it can lie and run freely in rail 5. This makes it possible, as shown in FIG. 5, to create a significant distance between the lock 11, which the user must grasp and fasten, and the strap holder 10, to which the strap 6 is fastened.

As shown in FIG. 5, it is possible for the user in the depicted situation to operate the lock 11 in front of the free surface 9 of the roll container 4 positioned directly against side wall 3 and therefore without space constraints and without having to insert his fingers into the narrow gap between the rail 5 and roll container 4. The connection site 8 of strap 6 is then situated far to the other side of the free surface 9. As a result of the force acting in the direction of strap 6, the rail 5 in the area of connection site 8 is exposed to no unfavorable stresses; these are instead much lower than in a strap running only parallel to the front wall 2, in which the rails 5 are loaded at right angles to the side wall 3 to pull-out.

FIG. 6 shows a first variant of a securing device 13 according to the invention with the strap holder 10 and lock 11 disassembled, so that the rod 12, through which the two parts are kept at a distance from each other, is readily apparent. In the assembled state, the parts are kept in the correct position through cotter pins, screws, pins, etc. which are movable relative to one another, as is known from the prior art, and optionally by means of springs. This is readily apparent and applicable to one skilled in the art with knowledge of the invention.

FIGS. 7 and 8 show the rail 5 in one case with the securing device 13 removed, and in one case with the securing device 13 inserted. The arrow M shows the direction in which the securing device 13 can be “threaded” into the rail 5, and this threading can occur obliquely from above (the position of the arrow must be viewed in three dimensions), if the rail lies on a horizontal surface, as shown in FIGS. 7, 8, 12, 13. The dimensions of the cross section of rod 12 in the plane normal to the longitudinal extent are chosen so that the rod 12 fits into rail 5, as is apparent in FIGS. 8 and 13, and is movable therein in the direction of arrow L, parallel to the longitudinal axis of the rail when the fastening is released. The rod 12 can then lie either within the profile of the rail, as in FIG. 8, or protrude therefrom, as in FIG. 13.

In a known manner, the rail 5 has a periodically repeating wider (recesses 15) or narrower design relative to the profile of edges 20 of groove 19, which, in a usual manner, defines a pitch T (FIG. 8) of constant length.

Also in a known manner, the securing device 13 also has at least one holding foot 14 in the area of strap holder 10, and ordinarily there are at least two, preferably three such holding feet 14, which have a spacing relative to each other that corresponds to pitch T. The feet are thickened on their free end so that they can only be removed at right angles (normally) from the rail when their lengthwise position (position in the direction of the rail axis) coincides with the wider areas (recesses 15) of rail 5.

At least one lock foot 16, and preferably at least two of similar design, is also provided in a known manner in the area of lock 11 of the securing device 13. A small offset (a few millimeters, fractions of the pitch T) is preferably sufficient between the holding feet 14 and the at least one lock foot 16 in the longitudinal direction, relative to the pitch of the recesses 15, in order to facilitate successive threading of the securing device 13 (in the direction of arrow M) into rail 5. During oblique insertion of rod 12 with holding feet 14, the securing thereof in the rail 5 is already ensured when the lock foot 16 is threaded in.

The offset is preferably positive, i.e., the distance between the holding feet 14 and the lock foot 16 is greater than the distance of the corresponding recesses 15. This permits particularly simple and smooth assembly without motion reversal.

Fastening of the securing device 13 in rail 5 occurs in a known manner by means of at least one fastening pin 22, which can be operated by means of a handle 21. In this case, the at least one fastening pin 21, which fits into a recess 15 of the rail but cannot be moved in the rail, is secured by a spring in the fastening position and can be unlocked by means of the handle. The position of the fastening pin in the longitudinal direction relative to the holding feet is chosen so that they are displaced; if possible, by a half-pitch relative to their removal position so that the greatest overlap with the undercut groove 19 and therefore the greatest securing force is present.

According to the invention, there is a distance between the holding feet 14 and the lock feet 16 which corresponds to at least three times, preferably at least five times and more preferably at least seven times the length of pitch T. The distance between the holding feet 14 and the lock feet 16 lying initially against each other is then used, since this depth determines the depth to which the strap holder 10 is pushed into the slit between the container and side wall.

As an alternative, it can be stated that the distance between the strap holder 10 and the handle 21 has the cited dimensions and, in absolute size, it can be stated that this distance is at least 10 cm, preferably at least 15 cm and more preferably at least 20 cm. The measurement can refer to the side of the lock on the axis of the fastening pin 22, if one is present (FIG. 6), or otherwise to the geometric center of the axes of the fastening pins (FIG. 11). On the side of the strap holder 10, the measurement can be referred to the location where the strap force is transferred to a part that is rigidly (or in one piece) connected to rod 12.

Two alternatives for fastening strap 6 on strap holder 10 are shown in FIGS. 9 and 10. According to FIG. 9, the strap 6 is looped around a pin 17 (see FIGS. 6 to 8, whose axis would be a measurement point for distance), according to FIG. 10, it is connected to pivot laterally on a pin 18 (whose axis would be a measurement point for distance). In both cases it is therefore guaranteed that the strap 6 is not crumpled in the fastening area.

FIGS. 11 to 13 show an alternative securing device 13 in views according to those of FIGS. 6 to 8. Four holding feet 14 are then provided and two fastening pins 22, the design of the rail is more massive than in the first variant and the device protrudes from the rail but is not movable in it when the fastening pin is unlocked. The axis of pin 10, on the one hand, and the center between the axes of the two fastening pins 22, on the other, are used as reference points for alternative distance measurement. As is directly apparent, the distinction relative to the distance between the axis of the holding foot situated in the leftmost position in the depiction and the axis of the lock foot 16 is not significant in comparison with the distance per se.

FIGS. 6 and 11 also show a preferred activation 23 for lock 11: the fastening pin or pins 22 are removable from the recesses 15 of rail 5 against the force of a spring (not shown), whereupon the securing device 13 can be moved in rail 5. A support surface 24 firmly connected to the securing device 13 then serves as a detent for the thumbs of the user, whereas two wings 25 connected to the fastening pin or pins 22 are grasped by the index finger and middle finger from below and moved from the rail 5 against the force of the spring. The variant according to FIGS. 11-13 is then preferred, since here the support surface 24 lies closer to the strap holder 10 than the center between the fastening pins 22. If only one fastening pin 22 is provided, its axis is the reference location relative to which the support surface is to be moved toward the lock.

This displacement, which is not prescribed in the version according to FIGS. 6-8, facilitates handling, especially handling when wearing gloves. It is interesting that the question of mutual arrangement of the support surface and wings in the securing devices according to the prior art, in which the lock and the strap holder are provided immediately adjacent to each other, plays no role for operating convenience. The reason for this is that in the prior art no significant torque can occur around the axes parallel to the wall and normal to the rail (roughly corresponding to arrow M).

The invention is not restricted to the examples described and depicted but, especially depending on the shape of the rail, can be modified in different ways. All materials thus far commonly used in such fastening devices are usable, but high-strength plastic and various composite materials also offer themselves to one skilled in the art with knowledge of the invention.

### LIST OF REFERENCE NUMBERS

| | |
|---|---|
| 01 | Truck body |
| 02 | Front wall |
| 03 | Side wall |
| 04 | Roll container |
| 05 | Rail |
| 06 | Strap |
| 07 | Tightener |
| 08 | Connection site |
| 09 | Free surface |
| 10 | Strap holder |
| 11 | Lock |
| 12 | Rod |
| 13 | Securing device |
| 14 | Holding feet |
| 15 | Recesses |
| 16 | Lock feet |
| 17 | Pin |
| 18 | Pin |
| 19 | Groove |
| 20 | Edges |
| 21 | Handle |
| 22 | Fastening pin |
| 23 | Activation |
| 24 | Support surface |
| 25 | Wing |

1-10. (canceled)

11. A device for fastening a load in an interior of a truck body, a container or the like with a rail that has a pitch, the device comprising: a strap holder for positioning a strap against the rail; a lock connected to the strap holder for fastening the strap in position, wherein the lock and the strap holder are at a distance from each other that is at least three times a length of the pitch of the rail.

12. The device according to claim 11, wherein that the distance is at least five times the length of the pitch of the rail.

13. The device according to claim 12, wherein the distance is at least seven times the length of a pitch of the rail.

14. The device according to claim 11, further comprising rod that spans the distance and is insertable with the lock and the strap holder into rail,

15. The device according to claim 11, further comprising at least one holding foot in an area of the strap holder, which at least one holding foot cooperates with recesses of the rail.

16. The device according to claim 15, further comprising at least one lock foot in an area of lock so as to cooperate with recesses of the rail, wherein there is an offset between the holding foot and the at least one lock foot in a longitudinal direction relative to the pitch of the recesses.

17. The device according to claim 16, wherein the offset is positive.

18. The device according to claim 11, wherein the strap holder has a pin running substantially across the longitudinal direction of the rail, the strap being looped around the pin.

19. The device according to claim 11, wherein the strap holder has a pin positioned substantially perpendicular to the rail, the strap being fastened to the pin so as to pivot laterally.

20. The device according to claim 11, wherein the lock has an actuating mechanism comprising a support surface firmly connected to the fastening device and two wings connected to at least one fastening pin, wherein the support surface lies closer to the strap holder than an axial center between the fastening pins, or lies closer than an axis of one fastening pin.
